(19) United States
(12) Patent Application Publication
(10) Pub. No.: US 2021/0107776 A1
(43) Pub. Date: Apr. 15, 2021

(54) IMPACT ABSORBING DEVICE FOR A FORKLIFT

(71) Applicant: Haier US Appliance Solutions, Inc., Wilmington, DE (US)

(72) Inventors: Richard Gregory Gilbert, Louisville, KY (US); Mark Daniel Shirkness, Louisville, KY (US); Adam Christian Wiseman, Louisville, KY (US); Alan Christopher Ricchio, Mt. Washington, KY (US); Stephen Nicolas Hill, Louisville, KY (US)

(21) Appl. No.: 16/600,729

(22) Filed: Oct. 14, 2019

(51) Int. Cl. B66F 9/12; B66F 9/08; B66F 9/075

(52) U.S. Cl. CPC B66F 9/12; B66F 9/07513; B66F 9/08

(57) ABSTRACT

An impact absorbing device for a forklift is provided for absorbing impact forces generated as the forklift is manipulating a load, such as a pallet containing finished goods. The impact absorbing device is positioned between a mast and a fork assembly of the forklift and includes a base frame mounted to the mast and a strike frame mounted to the fork assembly. The strike frame is mechanically coupled to the base frame by a scissor mechanism such that the strike frame is movable relative to the base frame, and a strike cushion is positioned between the base frame and the strike frame for absorbing the impact forces generated when the strike frame moves toward the base frame.

### FIELD OF THE INVENTION

The present subject matter relates generally to forklifts, and more particularly to impact absorbing devices for reducing loads transferred to containers or loads being moved by forklifts.

### BACKGROUND OF THE INVENTION

Forklifts are powered vehicles commonly used in commercial and industrial settings for moving parts, finished goods, or other products from location to location. For example, forklifts are used in warehouses to move pallets or containers of product between locations for storage, distribution, or end use. Specifically, forklifts commonly include one or more “forks” or another suitable attachment that extend from the front of the vehicle for receipt within slots of a wooden pallet or another shipping container. These forks typically extend from a lift mechanism, commonly called a mast, to permit the raising and lowering of the load being moved.

Notably, the location of the mast and the various loading and lifting mechanisms mounted to the front of forklifts often obstruct the line of view between the operator and the load being moved. Thus, the operator may frequently have inherently poor visibility of the forklift load, resulting in difficulty in manipulating the load without striking structures and exerting undesirable forces on the pallet or container. Specifically, for example, if an operator is stacking multiple pallets adjacent each other or positioning a pallet against a wall or storage shelf, the pallet or its contents may frequently bump into another product, wall, or other structure. If the loads or forces imparted by such contact are transferred to the load being moved by the forklift load, damage may occur to the load or the forklift itself.

Accordingly, an improved forklift that reduces the likelihood of damaging products is desired. More specifically, in impact absorbing device for absorbing undesirable forces placed on a forklift load during manipulation by the forklift would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an impact absorbing device positioned between a mast and a fork assembly of a forklift is provided. The impact absorbing device includes a base frame mounted to the mast and a strike frame mounted to the fork assembly. The strike frame is mechanically coupled to the base frame such that the strike frame is movable relative to the base frame and a strike cushion is positioned between the base frame and the strike frame for absorbing impact forces generated when the strike frame moves toward the base frame.

In another exemplary embodiment, a forklift is provided including a chassis, a mast mounted to a front of the chassis, a fork assembly, and an impact absorbing device positioned between the mast and the fork assembly. The impact absorbing device includes a base frame mounted to the mast, a strike frame mounted to the fork assembly, the strike frame being mechanically coupled to the base frame such that the strike frame is movable relative to the base frame, and a strike cushion positioned between the base frame and the strike frame for absorbing impact forces generated when the strike frame moves toward the base frame.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a forklift and an impact absorbing device for use with the forklift according to an exemplary embodiment of the present subject matter.

FIG. 2 provides another perspective view of the exemplary forklift and impact absorbing device of FIG. 1 according to an exemplary embodiment of the present subject matter.

FIG. 3 provides a perspective view of the exemplary impact absorbing device of FIG. 1 according to an exemplary embodiment of the present subject matter.

FIG. 4 provides a close-up perspective view of a scissor mechanism for use with the exemplary impact absorbing device of FIG. 1 according to an exemplary embodiment of the present subject matter.

FIG. 5 provides a top schematic view of the exemplary impact absorbing device of FIG. 1 according to an exemplary embodiment of the present subject matter.

FIG. 6 provides a side view of an exemplary impact absorbing device according to another exemplary embodiment of the present subject matter.

FIG. 7 provides a perspective view of the exemplary impact absorbing device of FIG. 6 according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components.

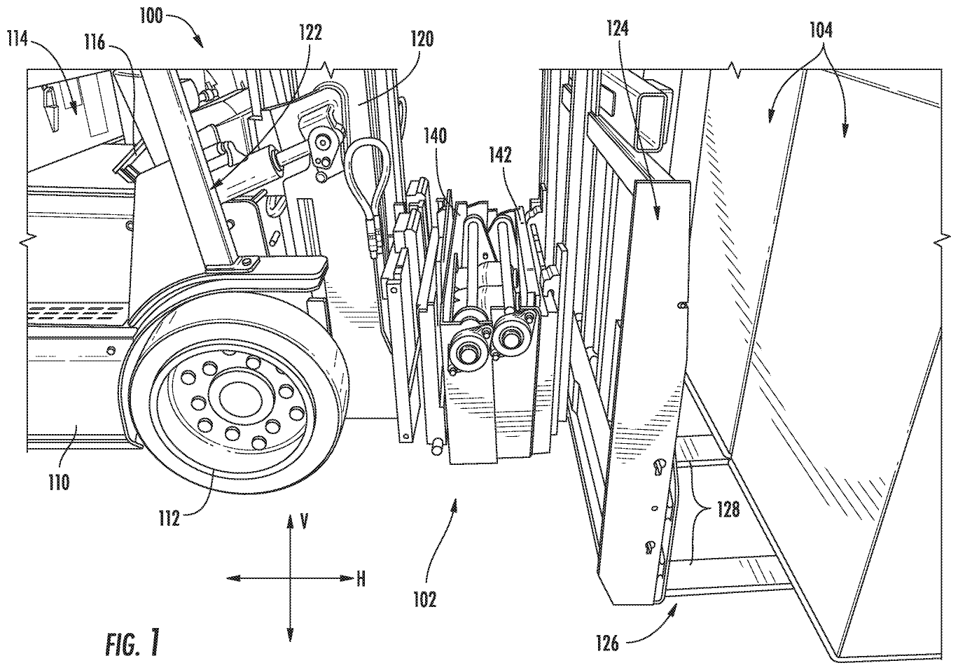

Referring now to the figures, an exemplary forklift 100 and impact absorbing device 102 will be described according to an exemplary embodiment of the present subject matter. Specifically, as best shown in FIG. 1, forklift 100 is generally configured for manipulating a pallet, a container, a carton, or another product, referred to herein generally as a load 104. Specifically, as illustrated, load 104 includes one or more shipping containers or boxes containing a consumer appliance. As described below, impact absorbing device 102 is positioned and configured for absorbing undesirable forces experienced by load 104 when being manipulated by forklift 100. Although load 104 is illustrated as an appliance container, it should be appreciated that the type of load 104 moved by forklift 100 and the way forklift 100 secures or supports load 104 may vary while remaining within the scope of the present subject matter.

In general, forklift 100 may be any suitable size, lift capacity, and design commonly known for moving loads 104. As illustrated, forklift 100 may generally include a chassis 110 that is moved by a plurality of wheels 112. Although not illustrated, wheels 112 may be mechanically coupled to one or more drive motors or engines that may be powered using any suitable power source, such as batteries, internal combustion engines, etc. On top of chassis 110, forklift 100 may include an operator compartment 114 with various controls 116 to permit the forklift operator to control the movement of forklift 100.

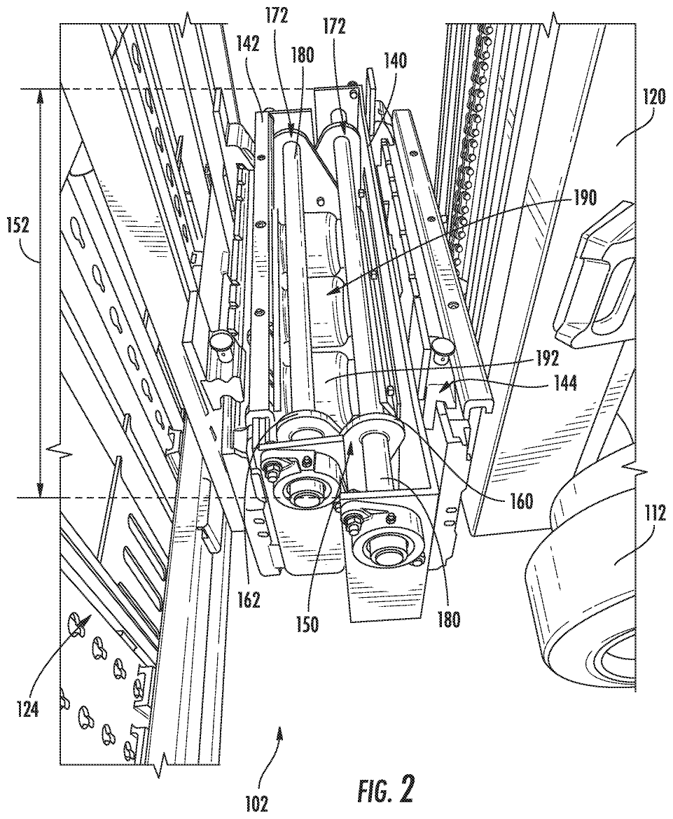

Referring now also to FIG. 2, forklift 100 may further include a mast 120 that is mounted to a front 122 of forklift 100 and is operably coupled to an attachment assembly 124. Specifically, according to the illustrated embodiment, attachment assembly 124 includes a fork assembly 126. In general, fork assembly 126 includes one or more forks 128 that extend from mast 120 substantially along a horizontal direction H. Although attachment assembly 124 is illustrated herein is being a fork assembly 126, it should be appreciated that other attachment assemblies are possible and within the scope of the present subject matter. In this regard, any other suitable means for attaching a load 104 to mast 120 may be used.

According to an exemplary embodiment, mast 120 is generally configured for moving load 104 along a vertical direction V, e.g., using hydraulic or electric actuators. In addition, mast 120 may be configured for adjusting an angle of load 104 (e.g., tilting the load 104 backward), extending or retracting the load 104 relative to front 122 of forklift 100, or otherwise manipulating or positioning load 104. Notably, as explained above, due to the position of mast 120, attachment assembly 124, and the load 104 supported by mast 120, the operator's line of sight to the load 104 may be blocked or impaired, resulting in difficulty positioning load 104. As a result, operators are commonly required to operate “blind” and may inadvertently knock or bump load 104 against other containers, walls, or other structures. Aspects of the present subject matter are directed to impact absorbing device 102, which is generally designed and positioned for reducing the effects of such impacts.

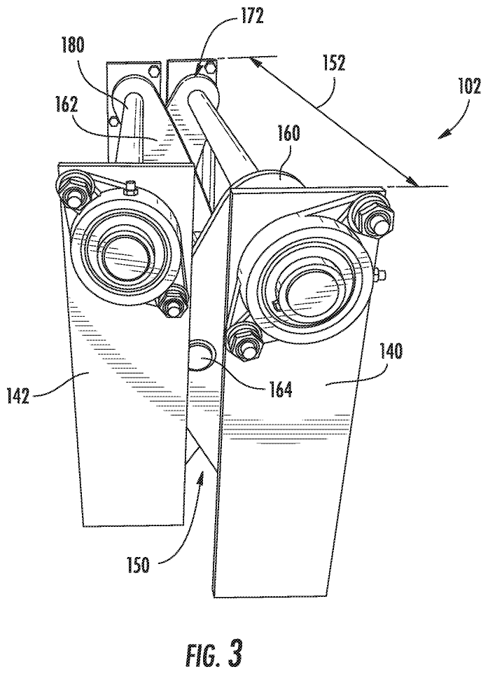

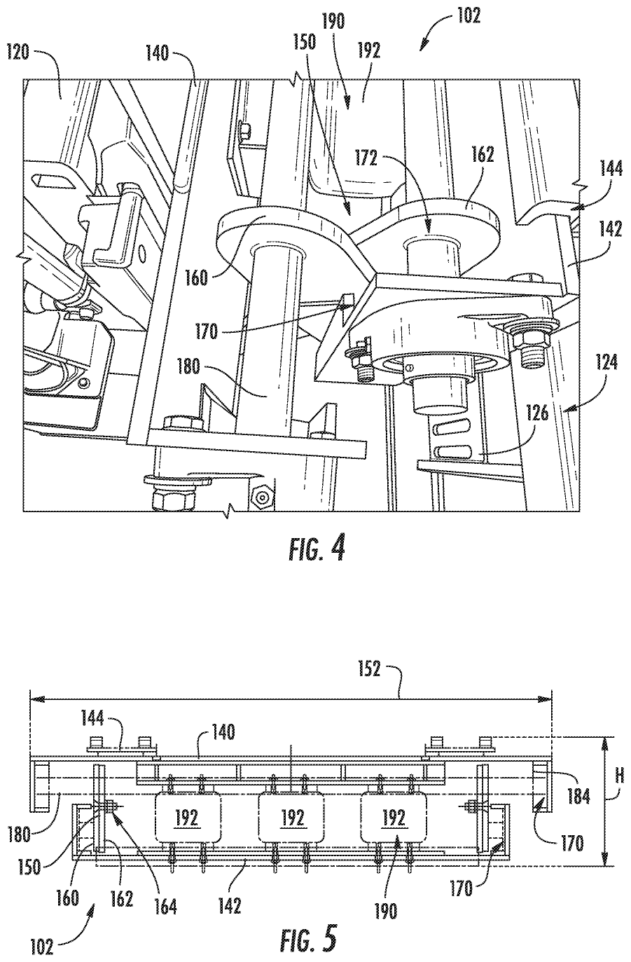

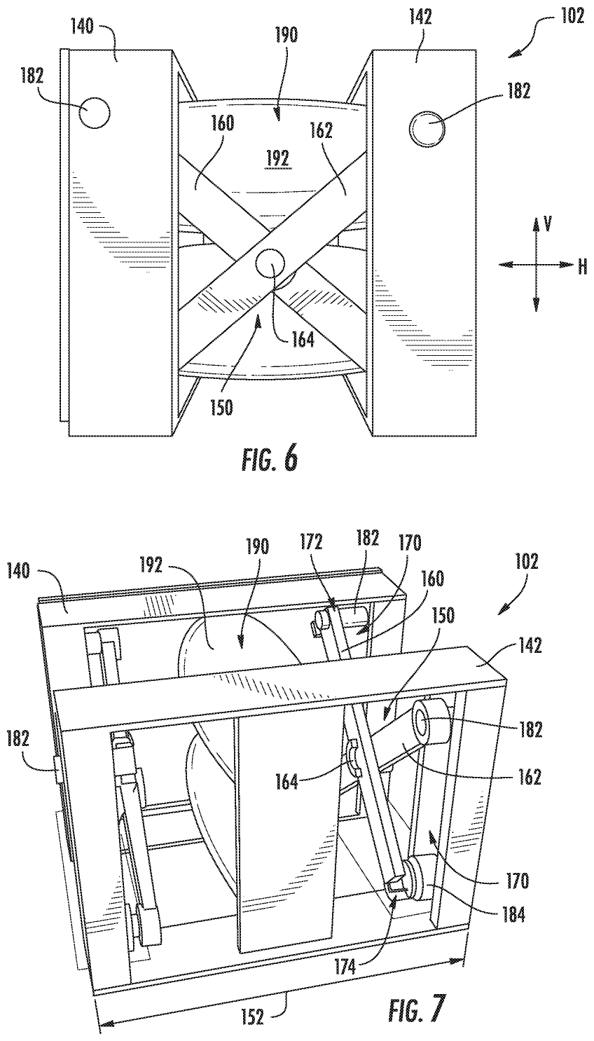

Specifically, referring now generally to FIGS. 1 through 5, impact absorbing device 102 is positioned between mast 120 and fork assembly 126. In operation, fork assembly 126 is cantilevered from mast 120 and supported entirely by impact absorbing device 102. In this manner, impact absorbing device 102 isolates and cushions fork assembly 126. As a result, forces exerted when forklift 100 pushes load 104 against a solid structure may be partially absorbed by impact absorbing device 102, resulting in fewer harmful impacts to load 104. FIGS. 6 and 7 illustrate an alternative embodiment of impact absorbing device 102. However, due to similarity in structure and functioning of the various embodiments, like reference numerals may be used to refer to the same or similar components in each embodiment.

As illustrated, impact absorbing device 102 includes a base frame 140 mounted to mast 120 and a strike frame 142 mounted to fork assembly 126. Any suitable method of mechanically attaching base frame 140 to mast 120 and strike frame 142 to fork assembly 126 may be used while remaining within the scope of the present subject matter. For example, as illustrated, a clamping member 144 is used to achieve such mechanical attachment. According to alternative embodiments, clamping member 144 may be replaced by a plurality of mechanical fasteners, welded joints, etc. According to the illustrated embodiment, base frame 140 and strike frame 142 are both oriented in a plane orthogonal to horizontal direction H (e.g., when not being tilted by mast 120).

Notably, strike frame 142 is mechanically coupled to base frame 140 such that strike frame 142 is movable relative to base frame 140. More specifically, according to the illustrated embodiment, base frame 140 and strike frame 142 may move relative to each other within a horizontal plane (e.g. when mast 120 is not in an inclined position). Specifically, according to the illustrated embodiment, impact absorbing device 102 includes a scissor mechanism 150 that permits such movement between base frame 140 and strike frame 142. Although a single scissor mechanism 150 (e.g., including two linkages) is described herein, it should be appreciated that base frame 140 and strike frame 142 may be coupled by any suitable number of scissor mechanisms 150. Specifically, as illustrated, impact absorbing device 102 includes two scissor mechanisms 150 spaced apart along a width 152 of impact absorbing device 102.

As illustrated, scissor mechanism 150 includes a first linkage arm 160 and a second linkage arm 162 that each extend between base frame 140 and strike frame 142. In addition, first linkage arm 160 and second linkage arm 162 are joined by a linkage pin 164. According to the illustrated embodiment, linkage pin 164 is positioned approximately at a center or midpoint of each of the first linkage arm 160 and the second linkage arm 162, e.g., such that linkage arms 162 form an “X” and are rotatable relative to each other. In general, first linkage arm 160 and second linkage arm 162 are rotatably and/or slidably attached to frames 140, 142 to form a linkage system that permits relative movement while still providing vertical support to load 104.

According to an exemplary embodiment, and as best illustrated in FIGS. 6 and 7, each of base frame 140 and strike frame 142 may define an elongated slot 170 that is configured for slidably receiving at least one of first linkage arm 160 and second linkage arm 162. More specifically, elongated slot 170 may be defined as a vertically extending flange or a groove cut into a side of frames 140, 142. According to the illustrated embodiment, each of first linkage arm 160 and second linkage arm 162 have a first end (referred to herein as top end 172 of linkage arms 160, 162) and a second end (referred to herein as bottom end 174 of linkage arms 160, 162). To facilitate relative horizontal motion between frames 140, 142, first linkage arm 160 is rotatably or pivotally attached to a top of base frame 140 at top end 172 and is slidably mounted within the elongated slot 170 of strike frame 142 at bottom end 174. Similarly, top end 172 of second linkage arm 162 is pivotally attached to a top of strike frame 142 and is slidably mounted within elongated slot 170 of base frame 140 at bottom end 174.

According to exemplary embodiments, top end 172 and bottom end 174 of linkage arms 160, 162 may be coupled to frames 142 using any suitable mechanical attachment or coupler. For example, as illustrated in FIGS. 1 through 5, impact absorbing device 102 includes a plurality of scissor mechanisms 150 that are joined by elongated pins 180 that extend along a width 152 of impact absorbing device 102. In this regard, elongated pins 180 rotatably mount top end 172 of first linkage arm 160 to base frame 140 and rotatably mount top end 172 of second linkage arm 162 to strike frame 142. Similarly, bottom ends 174 of first linkage arm 160 and second linkage arm 162 may also be joined by an elongated pin that is not coupled to frames 140, 142, e.g., to permit sliding of bottom ends 174 within elongated slot 170. According to still another embodiment illustrated in FIGS. 6 and 7, each top end 172 is mounted to base frame 140 or strike frame 142 by a shortened pin 182, while bottom ends 174 are mechanically coupled to a roller 184 that sits within elongated slot 170. In general, base frame 140, strike frame 142, and scissor mechanisms 150 may be made from any suitably rigid material materials, such as hardened steel.

As best shown in FIGS. 2, 4, and 5, impact absorbing device 102 further include one or more strike cushions 190 that are positioned between base frame 140 and strike frame 142 for absorbing impact forces generated when strike frame 142 moves toward base frame 140, such as when load 104 strikes an external structure. In this manner, forces exerted by forklift 102 pushing against the external structure are not transferred to load 104 but are instead absorbed by impact absorbing device 102. According to exemplary embodiments, strike cushion 190 may be any suitably resilient member for absorbing impact forces, such as a foam pad. More specifically, according to the illustrated embodiment, strike cushion 190 is a bag 192 filled with compressed gas for absorbing energy from impacts. Other suitable strike cushions 190 are possible and within the scope of the present subject matter.

As explained above, impact absorbing device 102 is designed to absorb forces generated when manipulating a load 104 using a forklift 100. Specifically, when a forklift 100 pushes a load 104 into an external structure, the force generated by the forklift 100 is absorbed at least in part by impact absorbing device 102. By contrast, in the absence of impact absorbing device 102 the full force generated by forklift 100 is transferred directly from mast 120 into load 104. By using impact absorbing device 102 to reduce such forces, damage to loads 104, external structures, and forklift 100 may be reduced or eliminated altogether.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An impact absorbing device positioned between a mast and a fork assembly of a forklift, the impact absorbing device comprising:
a base frame mounted to the mast;
a strike frame mounted to the fork assembly, the strike frame being mechanically coupled to the base frame such that the strike frame is movable relative to the base frame; and
a strike cushion positioned between the base frame and the strike frame for absorbing impact forces generated when the strike frame moves toward the base frame.

2. The impact absorbing device of claim 1, further comprising:
a scissor mechanism for mechanically coupling the base frame to the strike frame.

3. The impact absorbing device of claim 2, wherein the scissor mechanism comprises:
a first linkage arm extending between the base frame and the strike frame;
a second linkage arm extending between the base frame and the strike frame; and
a linkage pin joining the first linkage arm and the second linkage arm approximately at a center of each of the first linkage arm and the second linkage arm.

4. The impact absorbing device of claim 1, wherein the base frame and the strike frame each define an elongated slot for slidably receiving at least one of the first linkage arm and the second linkage arm.

5. The impact absorbing device of claim 4, wherein the first linkage arm is pivotally mounted to the base frame and is slidably mounted within the elongated slot of the strike frame and the second linkage arm is pivotally mounted to the strike frame and is slidably mounted within the elongated slot of the base frame.

6. The impact absorbing device of claim 1, wherein the strike frame, the base frame, and the scissor mechanism are all made from hardened steel.

7. The impact absorbing device of claim 1, comprising:
a plurality of scissor mechanisms spaced apart along a width of the impact absorbing device.

8. The impact absorbing device of claim 7, wherein the plurality of scissor mechanisms further comprises:
one or more elongated pins that extend along the width of the impact absorbing device for coupling the plurality of scissor mechanisms.

9. The impact absorbing device of claim 1, wherein the strike cushion is a resilient foam pad.

10. The impact absorbing device of claim 1, wherein the strike cushion is a bag filled with compressed gas.

11. The impact absorbing device of claim 1, wherein the base frame and the strike frame are both oriented in a plane orthogonal to a horizontal direction.

12. The impact absorbing device of claim 1, wherein the mast is configured for selectively moving the impact absorbing device and the fork assembly along a vertical direction.

13. A forklift comprising:
a chassis;
a mast mounted to a front of the chassis;
a fork assembly; and
an impact absorbing device positioned between the mast and the fork assembly, the impact absorbing device comprising:
a base frame mounted to the mast;
a strike frame mounted to the fork assembly, the strike frame being mechanically coupled to the base frame such that the strike frame is movable relative to the base frame; and
a strike cushion positioned between the base frame and the strike frame for absorbing impact forces generated when the strike frame moves toward the base frame.

14. The forklift of claim 13, wherein the impact absorbing device further comprises a scissor mechanism for mechanically coupling the base frame to the strike frame, the scissor mechanism comprising:
a first linkage arm extending between the base frame and the strike frame;
a second linkage arm extending between the base frame and the strike frame; and
a linkage pin joining the first linkage arm and the second linkage arm approximately at a center of each of the first linkage arm and the second linkage arm.

15. The forklift of claim 13, wherein the base frame and the strike frame each define an elongated slot for slidably receiving at least one of the first linkage arm and the second linkage arm.

16. The forklift of claim 15, wherein the first linkage arm is pivotally mounted to the base frame and is slidably mounted within the elongated slot of the strike frame and the second linkage arm is pivotally mounted to the strike frame and is slidably mounted within the elongated slot of the base frame.

17. The forklift of claim 13, wherein the impact absorbing device further comprises:
a plurality of scissor mechanisms spaced apart along a width of the impact absorbing device.

18. The forklift of claim 17, wherein the plurality of scissor mechanisms further comprises:
one or more elongated pins that extend along the width of the impact absorbing device for coupling the plurality of scissor mechanisms.

19. The forklift of claim 1, wherein the strike cushion is a resilient foam pad or a bag filled with compressed gas.

20. The forklift of claim 13, wherein the mast is configured for selectively moving the impact absorbing device and the fork assembly along a vertical direction.
